(19) United States
(12) Patent Application Publication
(10) Pub. No.: US 2020/0276836 A1
(43) Pub. Date: Sep. 3, 2020

(54) MEDIUM CONVEYING DEVICE AND INKJET PRINTER

(71) Applicant: FUJIFILM Corporation, Tokyo (JP)

(72) Inventors: Jun YAMANOBE, Kanagawa (JP); Takashi FUKUI, Kanagawa (JP); Koji FURUKAWA, Kanagawa (JP)

(73) Assignee: FUJIFILM Corporation, Tokyo (JP)

(21) Appl. No.: 16/878,617

(22) Filed: May 20, 2020

Related U.S. Application Data
(63) Continuation of application No. PCT/JP2018/041391, filed on Nov. 7, 2018.

(30) Foreign Application Priority Data
Dec. 14, 2017 (JP) 2017-239620

(51) Int. Cl. B41J 11/00

(52) U.S. Cl. CPC B41J 11/0045

(57) ABSTRACT

Provided are a medium conveying device and an inkjet printer that can convey a medium stably. In a case where a paper P is conveyed along a plane in a conveying unit 40, a posture of the paper P is corrected by a posture correction unit 20, and then the paper P is delivered to the conveying unit 40 by a delivery unit 30. The delivery unit 30 holds a leading end portion of the paper P of which the posture is corrected by the posture correction unit 2 with a paper holding bar 31, and delivers the paper P to the conveying unit 40 by moving the paper holding bar 31 linearly along a conveying direction of the paper P by the conveying unit 40.

### CROSS-REFERENCE TO RELATED APPLICATIONS

This application is a Continuation of PCT International Application No. PCT/JP2018/041391 filed on Nov. 7, 2018, which claims priority under 35 U.S.C § 119(a) to Japanese Patent Application No. 2017-239620 filed on Dec. 14, 2017. Each of the above application(s) is hereby expressly incorporated by reference, in its entirety, into the present application.

### BACKGROUND OF THE INVENTION

### 1. Field of the Invention

The present invention relates to a medium conveying device and an inkjet printer, and particularly relates to a medium conveying device that conveys a medium for printing and an inkjet printer that performs printing on the medium for printing to be conveyed by the medium conveying device by an inkjet method.

### 2. Description of the Related Art

In a printer that performs printing while conveying a medium, in a case where the medium is conveyed in an inclined state, a problem such as an image being printed with inclination occurs. For this reason, in the printer that performs printing while conveying the medium, processing of removing an inclination (skew) is performed before the medium is sent to a conveyance mechanism.

JP2017-140736A discloses a method in which a medium is made to abut on a pair of stopped conveying rollers to remove an inclination, and then the pair of conveying rollers is rotated to send the medium to a conveyance mechanism.

JP2010-221552A discloses a configuration in which a leading end of a medium is made to abut on a front lay to remove an inclination of the medium, and then the medium is delivered by a rotating cylinder.

### SUMMARY OF THE INVENTION

However, the method of JP2017-140736A has a disadvantage that in a case where a diameter of each conveying roller is uneven, an inclination occurs in a case where the medium is sent by the pair of conveying rollers. That is, in a case where the diameter of each conveying roller is uneven, an outer circumferential speed of each conveying roller becomes uneven, and as a result, the medium to be sent is inclined.

Further, in a case of the configuration in which the medium is delivered by the rotating cylinder as in JP2010-221552A, there is a disadvantage that a degree of freedom in design is small because a position at which the medium can be delivered is limited. For this reason, in a case of the configuration in which the medium is delivered by the rotating cylinder, there is a disadvantage that, in principle, a conveyance mechanism on a side to which the medium is delivered is also limited to the cylinder.

The present invention has been made in view of such circumstances, and an object thereof is to provide a medium conveying device and an inkjet printer that can convey a medium stably.

Means for solving the above problems is as follows.

(1) A medium conveying device comprising: a posture correction unit that corrects a posture of a medium; a conveying unit that conveys the medium along a plane; and a delivery unit that delivers the medium of which the posture is corrected by the posture correction unit to the conveying unit, in which the delivery unit includes a holding portion that holds a part of the medium of which the posture is corrected by the posture correction unit, and delivers the medium to the conveying unit by moving the holding portion linearly along a conveying direction of the medium by the conveying unit.

According to this aspect, after the posture of the medium is corrected by the posture correction unit, the medium is delivered to the conveying unit by the delivery unit. That is, after the posture of the medium is adjusted to a specified posture in the posture correction unit, the medium is delivered to the conveying unit by the delivery unit. For example, in a case of a sheet, after front and rear edges of the sheet are adjusted to a posture orthogonal to the conveying direction by the conveying unit, the sheet is delivered to the conveying unit by the delivery unit. The delivery unit holds a part of the medium of which the posture is corrected by the posture correction unit by the holding portion, and delivers the medium to the conveying unit by moving the holding portion linearly along the conveying direction of the medium by the conveying unit. Accordingly, the medium can be delivered to the conveying unit in a state where the posture is corrected. The conveying unit conveys the medium delivered from the delivery unit along a plane. The delivery unit moves the holding portion linearly along the conveying direction of the medium by the conveying unit, so that the medium can be delivered to the conveying unit at any position.

(2) The medium conveying device according to (1), in which the delivery unit accelerates the holding portion to the same speed as a conveying speed of the medium by the conveying unit, and delivers the medium held by the holding portion to the conveying unit.

According to this aspect, the holding portion is accelerated to the same speed as the conveying speed of the medium by the conveying unit, and the medium is delivered to the conveying unit. Accordingly, it is possible to prevent the medium from being inclined or shifted in a case where the medium is delivered to the conveying unit from the holding portion.

The “same speed” here includes a range recognized as substantially the same speed. That is, a case where the holding portion is accelerated to almost the same speed as the conveying speed of the medium is included.

(3) The medium conveying device according to (1), in which the delivery unit accelerates the holding portion to a speed within a range of ±10% of a conveying speed of the medium by the conveying unit, and delivers the medium held by the holding portion to the conveying unit.

According to this aspect, the holding portion is accelerated to the speed within the range of ±10% of the conveying speed of the medium by the conveying unit, and the medium is delivered to the conveying unit. That is, the medium is accelerated and delivered such that a speed at which the medium is delivered to the conveying unit is within the range of ±10% of the conveying speed of the medium by the conveying unit. Accordingly, it is possible to prevent the medium from being inclined or shifted in a case where the medium is delivered to the conveying unit from the holding portion.

(4) The medium conveying device according to any one of (1) to (3), in which the conveying unit conveys the medium by a belt.

According to this aspect, the medium is conveyed by the belt in the conveying unit. That is, the medium is placed on the belt running on a certain path, and the medium is conveyed along the plane.

(5) The medium conveying device according to (4), in which the conveying unit conveys the medium by attracting the medium onto the belt.

According to this aspect, the medium is conveyed by being attracted onto the belt in the conveying unit. Accordingly, even in a case where the medium is light, the medium can be conveyed stably. A method of using air pressure (negative pressure), a method of using static electricity, or the like can be used for attraction of the medium. In the method of using air pressure, the medium is attracted onto the belt by punching a number of holes in the belt and performing suction from an inside of the belt. In the method of using static electricity, the belt is charged to a high voltage.

(6) The medium conveying device according to (5), in which the holding portion attracts and holds a leading end portion of the medium, and the delivery unit delivers the medium to the conveying unit by moving the holding portion to a position where an attraction force by the belt acts.

According to this aspect, the leading end portion of the medium is attracted and held by the holding portion. The holding portion moves to the position where the attraction force by the belt acts, and delivers the medium to the conveying unit. Accordingly, the medium can be delivered to the conveying unit with the minimum moving amount. In addition, a feeding speed of the medium can be increased.

(7) The medium conveying device according to (6), in which the holding portion attracts and holds the leading end portion of the medium with a plurality of suction holes which can be individually opened and closed, and the suction holes are individually opened and closed according to a size of the medium.

According to this aspect, the holding portion comprises the plurality of suction holes, and attracts and holds the leading end portion of the medium by performing suction from the suction holes. Each suction hole can be individually opened and closed, and is individually opened and closed according to the size of the medium. Accordingly, media of different sizes can be stably delivered.

(8) The medium conveying device according to any one of (1) to (7), in which the posture correction unit corrects the posture of the medium and positions the medium at a fixed position.

According to this aspect, in the posture correction unit, the posture of the medium is corrected, and the medium is positioned at the fixed position. Accordingly, the medium can be conveyed more stably.

(9) The medium conveying device according to (8), in which the posture correction unit corrects the posture of the medium and positions the medium at the fixed position by making the medium abut on a first regulating member disposed along a direction orthogonal to a delivery direction of the medium and a second regulating member disposed along the delivery direction of the medium.

According to this aspect, the posture of the medium is corrected and the medium is positioned at the fixed position by making the medium abut on a first regulating member disposed along a direction orthogonal to a delivery direction of the medium and a second regulating member disposed along the delivery direction of the medium. Accordingly, the medium can be positioned at the same time as the posture is corrected.

(10) The medium conveying device according to any one of (1) to (7), in which the posture correction unit corrects the posture of the medium and positions the medium at a fixed position with respect to a delivery direction of the medium.

According to this aspect, in the posture correction unit, the posture of the medium is corrected, and the medium is positioned at the fixed position with respect to the delivery direction of the medium. Accordingly, the medium can be conveyed more stably.

(11) The medium conveying device according to (10), in which the posture correction unit corrects the posture of the medium and positions the medium at the fixed position with respect to the delivery direction of the medium by making the medium abut on a regulating member disposed along a direction orthogonal to the delivery direction of the medium.

According to this aspect, the posture of the medium is corrected and the medium is positioned at the fixed position with respect to the delivery direction of the medium by making the medium abut on the regulating member disposed along the direction orthogonal to the delivery direction of the medium. Accordingly, the medium can be positioned at the same time as the posture is corrected.

(12) The medium conveying device according to any one of (1) to (7), in which the posture correction unit corrects the posture of the medium and positions the medium at a fixed position with respect to a direction orthogonal to a delivery direction of the medium.

According to this aspect, in the posture correction unit, the posture of the medium is corrected, and the medium is positioned at the fixed position with respect to the direction orthogonal to the delivery direction of the medium. Accordingly, the medium can be conveyed more stably.

(13) The medium conveying device according to (12), in which the posture correction unit corrects the posture of the medium and positions the medium at the fixed position with respect to the direction orthogonal to the delivery direction of the medium by making the medium abut on a regulating member disposed along the delivery direction of the medium.

According to this aspect, the posture of the medium is corrected and the medium is positioned at the fixed position with respect to the direction orthogonal to the delivery direction of the medium by making the medium abut on the regulating member disposed along the delivery direction of the medium. Accordingly, the medium can be positioned at the same time as the posture is corrected.

(14) The medium conveying device according to any one of (1) to (7), in which the posture correction unit includes a posture detecting portion that detects the posture of the medium, a plurality of conveying rollers disposed along a direction orthogonal to a delivery direction of the medium, and a control unit that individually controls rotation speeds of the conveying rollers based on a detection result of the posture detecting portion and corrects the posture of the medium.

According to this aspect, the posture of the medium is corrected by individually controlling the rotation speeds of the plurality of conveying rollers disposed along the direction orthogonal to the delivery direction of the medium. The rotation speed of each conveying roller is set based on the posture of the medium detected by the posture detecting portion.

(15) An inkjet printer comprising: the medium conveying device according to any one of (1) to (14); and an inkjet printing unit that performs printing on the medium conveyed by the conveying unit of the medium conveying device by an inkjet method.

According to this aspect, in the inkjet printer that performs printing by the inkjet method, the medium is conveyed by using the medium conveying device described in any one of (1) to (14). Accordingly, it is possible to prevent a problem such as an image being printed with inclination from occurring.

According to the present invention, a medium can be stably conveyed.

### BRIEF DESCRIPTION OF THE DRAWINGS

FIG. 1 is a schematic configuration view showing an embodiment of an inkjet printer to which the present invention is applied.

FIG. 2 is a plan view showing a schematic configuration of a posture correction unit.

FIG. 3 is a side view showing the schematic configuration of the posture correction unit.

FIG. 4 is a plan view showing a schematic configuration of a delivery unit.

FIG. 5 is a cross-sectional front view of a paper holding bar.

FIG. 6 is a bottom view of the paper holding bar.

FIG. 7 is a plan view of a conveying unit and a printing unit.

FIG. 8 is a block diagram showing a schematic configuration of a control system of the inkjet printer.

FIG. 9 is a plan view showing an example of a posture correction unit in a case where positioning is performed in a direction orthogonal to a conveying direction of a paper.

FIG. 10 is a plan view showing an example of a posture correction unit in a case where only a posture of the paper is corrected.

FIG. 11 is a table showing results of an experiment.

### DESCRIPTION OF THE PREFERRED EMBODIMENTS

Hereinafter, preferred embodiments of the present invention will be described in detail with reference to the accompanying drawings.

[Configuration of Inkjet Printer]

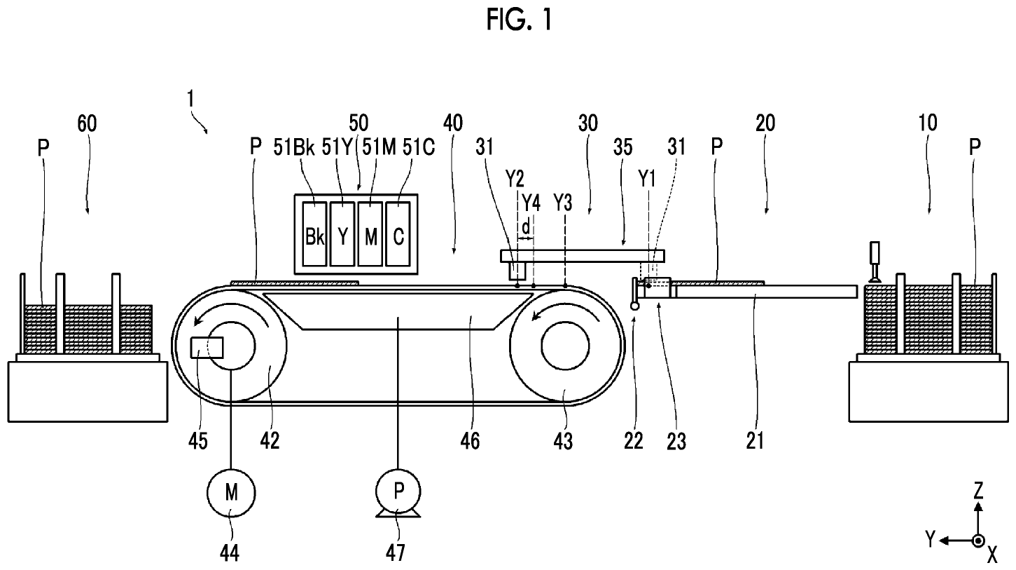

FIG. 1 is a schematic configuration view showing an embodiment of an inkjet printer to which the present invention is applied.

An inkjet printer 1 is a line printer that performs printing on a sheet by a single pass using a line head, and comprises a paper feeding unit 10, a posture correction unit 20, a delivery unit 30, a conveying unit 40, an inkjet printing unit 50, and a paper discharging unit 60. The posture correction unit 20, the delivery unit 30, and the conveying unit 40 form a medium conveying device. After a posture of a paper P supplied from the paper feeding unit 10 is corrected by the posture correction unit 20, the paper P is delivered to the conveying unit 40 by the delivery unit 30, is printed by the inkjet printing unit 50, and is discharged to the paper discharging unit 60.

<<Paper Feeding Unit>>

The paper feeding unit 10 supplies the paper P to the posture correction unit 20 one by one. The paper feeding unit 10 is configured by a known paper feeding mechanism, separates the stacked papers P one by one, and supplies the separated paper P to the posture correction unit 20. A paper feeding direction of the paper feeding unit 10 is the same as a conveying direction of the paper P by the posture correction unit 20. This direction is a Y direction in FIG. 1.

<<Posture Correction Unit>>

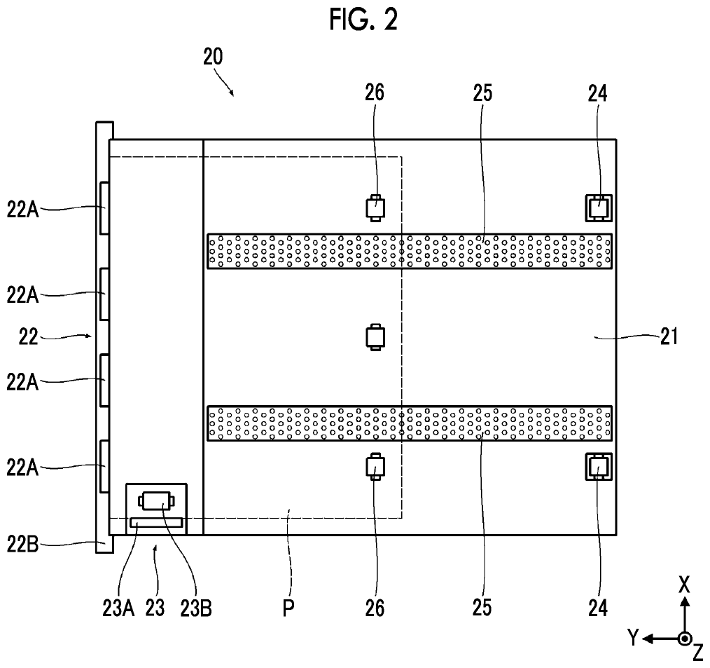

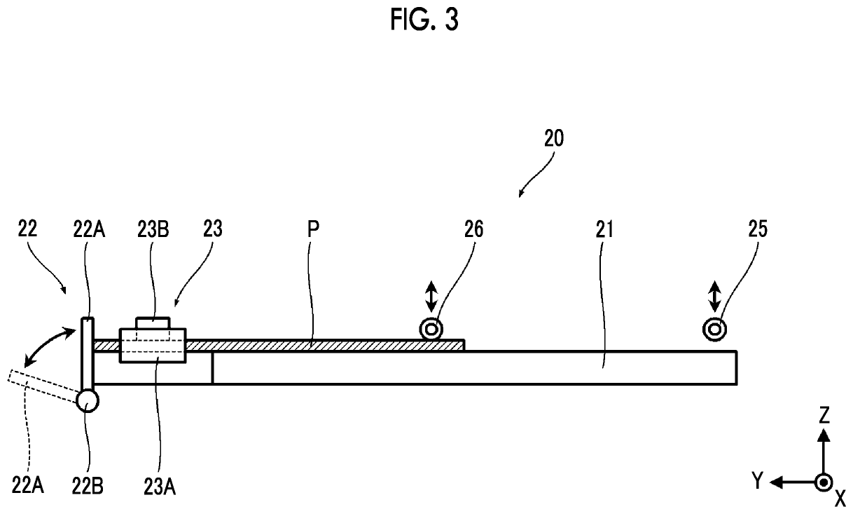

FIG. 2 is a plan view showing a schematic configuration of a posture correction unit. FIG. 3 is a side view showing the schematic configuration of the posture correction unit.

The posture correction unit 20 conveys the paper P to a specified position (a position where the paper P is delivered to the delivery unit 30), and corrects a posture of the paper P in the conveyance process. In the present embodiment, the posture of the paper P is corrected so that front and rear edges of the paper P in the conveying direction (Y direction) are set to a posture orthogonal to the conveying direction of the paper P as a specified posture. That is, an inclination (skew) around a Z axis is corrected.

The conveying direction of the paper P by the posture correction unit 20 is the same as a direction in which the delivery unit 30 delivers the paper P to the conveying unit 40. This direction is a Y direction in FIG. 1. The posture correction unit 20 comprises a feeder board 21, a front lay device 22, a side lay device 23, and the like.

<Feeder Board>

The feeder board 21 conveys the paper P supplied from the paper feeding unit 10 toward the front lay device 22. The feeder board 21 comprises a paper feed roller 24, a paper feed belt 25, a paper feed roll 26, and the like. The paper P supplied from the paper feeding unit 10 is conveyed on the feeder board 21 toward the front lay device 22 by the paper feed roller 24, the paper feed belt 25, and the paper feed roll 26. The paper feed roller 24, the paper feed belt 25, and the paper feed roll 26 are driven in synchronization with feeding of the paper P. The paper feed roller 24 and the paper feed roll 26 are moved up and down in synchronization with feeding of the paper P.

<Front Lay Device>

The front lay device 22 comprises a plurality of front lays 22A, and corrects the posture of the paper P by making a front edge (edge on a leading end side) of the paper P abut on the front lays 22A. At the same time, the front lay device 22 positions the paper P at a fixed position with respect to a delivery direction (Y direction). The front lay 22A is an example of a first regulating member, and is disposed along a direction orthogonal to the conveying direction (Y direction) of the paper P by the feeder board 21. The front lay 22A is provided on a front lay shaft 22B, and is retracted from a conveying path of the paper P by the feeder board 21 by rotating the front lay shaft 22B.

<Side Lay Device>

The side lay device 23 comprises a side lay 23A and a side lay roll 23B, and corrects the posture of the paper P by making a side edge of the paper P abut on the side lay 23A. At the same time, the front lay device 22 positions the paper P at a fixed position with respect to a direction (X direction) orthogonal to the delivery direction (Y direction). The side lay 23A is an example of a second regulating member, and is disposed along the conveying direction (Y direction) of the paper P by the feeder board 21. The side lay roll 23B feeds the paper P, which has abutted on the front lay 22A, in the direction (X direction) orthogonal to the conveying direction (Y direction), so that the side edge of the paper P is made to abut on the side lay 23A.

The posture correction unit 20 is configured as described above. In the posture correction unit 20, the paper P is first applied to the front lay 22A, and then to the side lay 23A. Thus, the posture is corrected and positioning is performed at a fixed position.

<<Delivery Unit>>

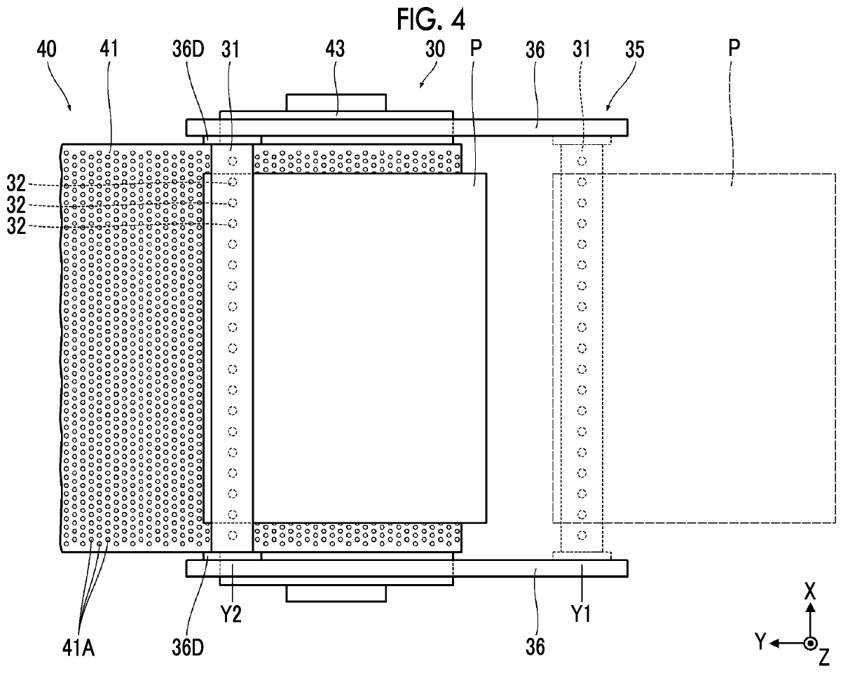

FIG. 4 is a plan view showing a schematic configuration of a delivery unit.

The delivery unit 30 delivers the paper P of which the posture is corrected by the posture correction unit 20 and which is positioned at a fixed position to the conveying unit 40. The delivery direction of the paper P by the delivery unit 30 is the same as the conveying direction of the paper P by the conveying unit 40. This direction is a Y direction in FIG. 4. The delivery unit 30 comprises a paper holding bar 31 that holds the paper P, and a paper holding bar moving mechanism 35 that linearly reciprocates the paper holding bar 31.

<Paper Holding Bar>

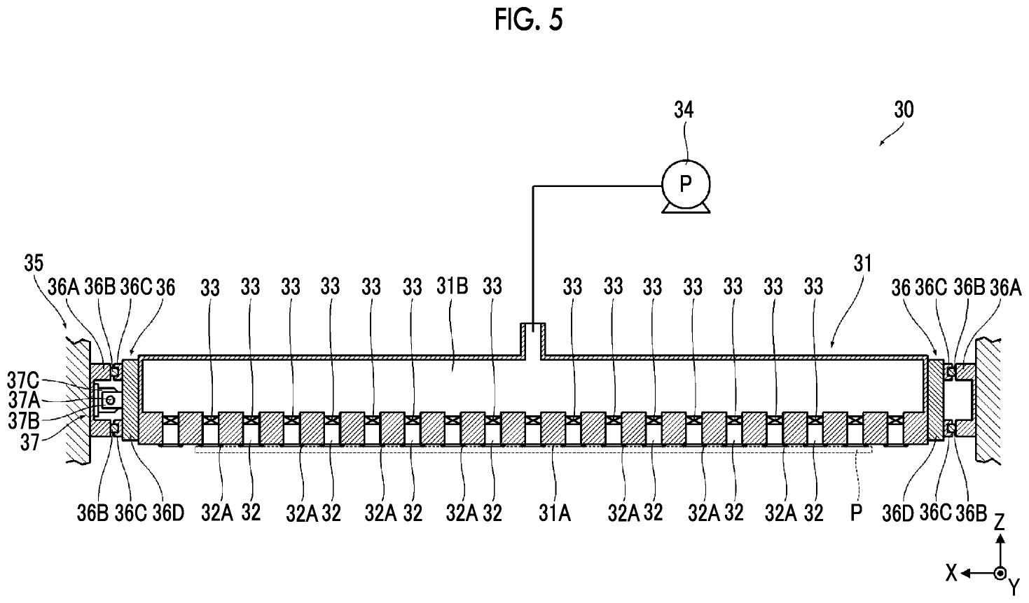

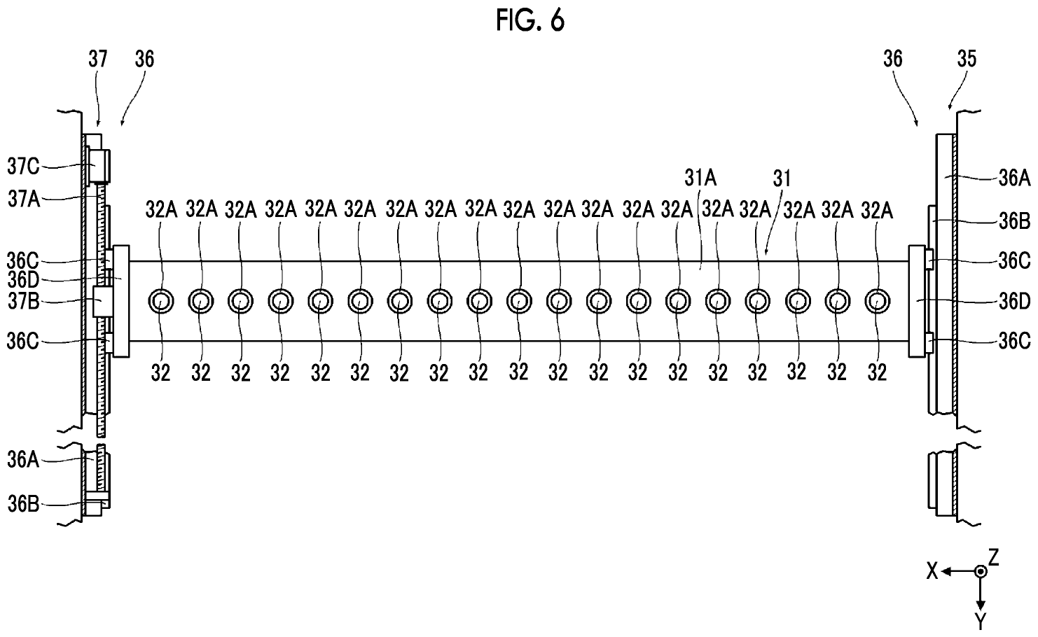

FIG. 5 is a cross-sectional front view of a paper holding bar. FIG. 6 is a bottom view of the paper holding bar.

The paper holding bar 31 is an example of a holding portion. The paper holding bar 31 has a square bar shape, and is disposed along a direction orthogonal to the delivery direction (Y direction) of the paper P.

A bottom surface portion of the paper holding bar 31 serves as an attraction surface 31A for the paper P. The paper holding bar 31 attracts the paper P onto the attraction surface 31A, and attracts and holds a leading end portion of the paper P. The attraction surface 31A is formed of a surface parallel to the paper P to be conveyed by the conveying unit 40. Specifically, in FIG. 1, it is configured on a plane in parallel to an XY plane.

As shown in FIG. 6, the attraction surface 31A comprises a plurality of suction holes 32. The suction holes 32 are disposed at regular intervals along the direction (X direction) orthogonal to the delivery direction (Y direction) of the paper P. Each suction hole 32 comprises a rubber pad 32A at a portion of a suction port.

As shown in FIG. 5, each suction hole 32 is communicated with a common space 31B inside the paper holding bar 31. Each suction hole 32 comprises a suction hole opening/closing valve 33. The suction hole opening/closing valve 33 is formed of, for example, an electromagnetic valve, and opening/closing is individually controlled. Thus, each suction hole 32 is configured to be able to be individually opened and closed.

A paper holding bar suction pump 34 is connected to the common space 31B. By driving the paper holding bar suction pump 34, the common space 31B is sucked, and suction is performed through the suction hole 32 communicated with the common space 31B.

<Paper Holding Bar Moving Mechanism>

The paper holding bar moving mechanism 35 comprises a pair of linear motion guides 36 that guides movement of the paper holding bar 31 and a paper holding bar driving mechanism 37 that moves the paper holding bar 31.

The linear motion guide 36 comprises a base 36A, a pair of guide rails 36B disposed on the base 36A, and a slide table 36D that slides on the guide rail 36B via a slider 36C. The guide rail 36B is disposed along the delivery direction (Y direction) of the paper P. Therefore, the slide table 36D slides along the delivery direction (Y direction) of the paper P.

The pair of linear motion guides 36 is disposed on both sides of the paper holding bar 31. Each of both ends of the paper holding bar 31 is fixed to the slide table 36D of the linear motion guide 36. Thus, the paper holding bar 31 is supported movably along the delivery direction (Y direction) of the paper P.

The paper holding bar driving mechanism 37 is provided on one linear motion guide 36, and moves the slide table 36D of the one linear motion guide 36 along the guide rail 36B. The paper holding bar driving mechanism 37 is configured by a so-called feed screw mechanism, and has a feed screw 37A, a nut 37B fastened to the feed screw 37A, and a feed screw drive motor 37C that rotates the feed screw 37A. The feed screw 37A is disposed between the pair of guide rails 36B, and is disposed along the guide rail 36B. The nut 37B is provided integrally with the slide table 36D. The feed screw drive motor 37C is provided on the base 36A.

In a case where the feed screw drive motor 37C is driven, the feed screw 37A rotates, and the slide table 36D moves according to the amount of rotation. Thus, the paper holding bar 31 moves along the delivery direction (Y direction) of the paper P.

The delivery unit 30 is configured as described above. In the delivery unit 30, the paper holding bar 31 moves linearly, and delivers the paper P from the posture correction unit 20 to the conveying unit 40. A position at which the paper holding bar 31 receives the paper P from the posture correction unit 20 is defined as a receiving position Y1, and a position at which the paper holding bar 31 delivers the paper P to the conveying unit 40 is defined as a delivery position Y2. The paper holding bar 31 linearly moves from the receiving position Y1 to the delivery position Y2, and delivers the paper P to the conveying unit 40.

In a case where the paper holding bar 31 is located at the receiving position Y1, the paper holding bar 31 is disposed with a certain clearance directly above the leading end portion of the paper P of which the posture is corrected by the posture correction unit 20. Thus, in a case where suction is performed at the receiving position Y1, the leading end portion of the paper P can be attracted and held by the paper holding bar 31. The delivery position Y2 will be described later.

<<Conveying Unit>>

The conveying unit 40 receives the paper P from the delivery unit 30, and conveys the paper P in one direction along a plane. Specifically, in FIG. 1, the paper P is conveyed in the Y direction along the XY plane. The conveying unit 40 is configured by a so-called belt conveyance mechanism, and conveys the paper P by attracting the paper P onto a conveying belt 41. Air pressure (negative pressure) is used for attraction.

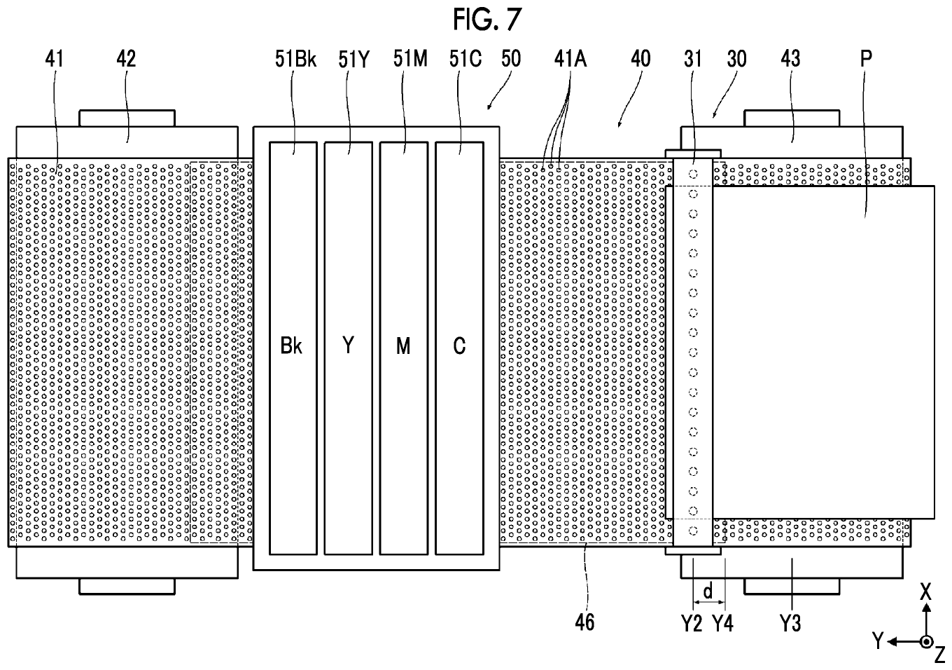

The conveying belt 41 is an endless belt comprising a large number of suction holes 41A (see FIG. 7). The conveying belt 41 is wound around a driving roller 42 and a driven roller 43.

The driving roller 42 and the driven roller 43 are disposed along a direction orthogonal to the conveying direction (Y direction) of the paper P, and are disposed on the same plane. Thus, a flat conveyance path is formed by the conveying belt 41. This conveyance path conveys the paper P in the Y direction along the XY plane.

A conveying belt drive motor 44 is connected to the driving roller 42. By driving the conveying belt drive motor 44, the driving roller 42 rotates. Thus, the conveying belt 41 runs.

The driving roller 42 comprises a rotary encoder 45. The rotary encoder 45 detects the amount of rotation of the driving roller 42. A running speed of the conveying belt 41 is detected based on output of the rotary encoder 45. The running speed of the conveying belt 41 is synonymous with the conveying speed of the paper P.

A suction chamber 46 is provided inside the conveying belt 41. The suction chamber 46 is connected to a conveying belt suction pump 47. The suction chamber 46 suctions the conveying belt 41 from the inside in an area constituting the conveyance path of the paper P.

Here, assuming that a start point of the conveyance path of the paper P is denoted by Y3 and a start point of suction action by the suction chamber 46 is denoted by Y4, the start point Y4 of suction action is located downstream of the start point Y3 of the conveyance path due to an installation space of the suction chamber 46.

As described above, the paper P is delivered from the paper holding bar 31 to the conveying belt 41 at the delivery position Y2. That is, at the delivery position Y2, holding of the paper P by the paper holding bar 31 is released.

In a case where the paper holding bar 31 is located at the delivery position Y2, the paper holding bar 31 is disposed directly above the conveying belt 41 with a certain clearance. The delivery position Y2 of the paper P is set on the conveyance path of the paper P by the conveying belt 41 and at least a position where the attraction force acts. Therefore, the delivery position Y2 is set downstream of the start point Y4 of suction action. Thus, in a case where holding of the paper P is released, the paper P can be reliably delivered to the conveying belt 41. In the present embodiment, the delivery position Y2 is set at a point apart from the start point Y4 of suction action by the suction chamber 46 by a distance d. By setting the distance d to be short, the amount of movement of the paper holding bar 31 during delivery can be reduced. For example, the delivery position Y2 is set such that holding of the paper P is released at a time when the suction hole 32 of the paper holding bar 31 passes the start point Y4 of the suction action. Thus, a moving distance of the paper holding bar 31 can be shortened while preventing a shift or the like.

The conveying unit 40 is configured as described above. The paper P is delivered to the running conveying belt 41, is attracted onto a surface of the conveying belt 41, and is conveyed at a constant speed along the conveyance path.

In a case where the paper P is delivered to the conveying belt 41, the paper P is accelerated to the same speed as the conveying belt 41. Thus, it is possible to prevent the paper P from being inclined or shifted during delivery. Here, the same speed includes a range recognized as substantially the same speed. The driving of the paper holding bar 31 is controlled based on information on the running speed of the conveying belt 41 (the conveying speed of the paper P) to be acquired via the rotary encoder 45. That is, movement of the paper holding bar 31 is controlled such that the speed becomes the same as the running speed of the conveying belt 41 during delivery.

<<Inkjet Printing Unit>>

FIG. 7 is a plan view of a conveying unit and a printing unit.

The inkjet printing unit 50 is disposed on the conveyance path of the paper P by the conveying unit 40, and drops four colors of ink of cyan (C), magenta (M), yellow (Y), and black (Bk) on the paper P conveyed along the conveyance path to print a color image on the paper P.

The inkjet printing unit 50 comprises an inkjet head 51C that ejects ink droplets of cyan, an inkjet head 51M that ejects ink droplets of magenta, an inkjet head 51Y that ejects ink droplets of yellow, and an inkjet head 51Bk that ejects ink droplets of black. The inkjet heads 51C, 51M, 51Y, and 51Bk are each configured by a line head corresponding to the maximum paper width, and are disposed along a direction orthogonal to the conveying direction (Y direction) of the paper P. The inkjet heads 51C, 51M, 51Y, and 51Bk are disposed at equal intervals along the conveying direction (Y direction) of the paper P.

Each of the inkjet heads 51C, 51M, 51Y, and 51Bk is driven in synchronization with the conveyance of the paper P based on data for printing.

<<Paper Discharging Unit>>

The paper discharging unit 60 collects the printed paper P from the conveying unit 40 and accumulates the paper P on a paper discharge tray.

[Control System of Inkjet Printer]

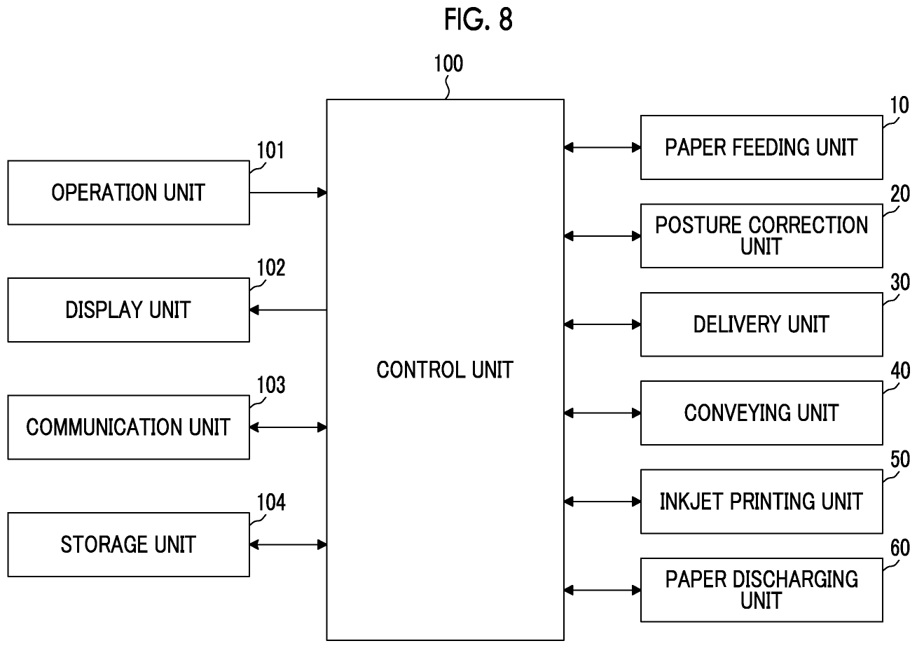

FIG. 8 is a block diagram showing a schematic configuration of a control system of the inkjet printer.

An overall operation of the inkjet printer 1 is integrally controlled by a control unit 100. The control unit 100 is configured by a computer, and controls operation of each unit by executing a predetermined control program. A operation unit 101 for operating the inkjet printer 1, a display unit 102 for displaying various pieces of information, a communication unit 103 for communicating with an external device, and a storage unit 104 for storing programs and various pieces of data necessary for control are connected to the control unit 100. The image data to be printed is acquired from an external device via the communication unit 103. The control unit 100 generates data for printing from the acquired image data and executes print processing.

[Action of Inkjet Printer]

In a case where the image data for printing is input, the control unit 100 generates data for printing. After that, print processing is started according to the print execution instruction.

First, the conveying unit 40 is driven, and running of the conveying belt 41 is started. After that, the paper P is supplied from the paper feeding unit 10 to the posture correction unit 20. The paper P is supplied from the paper feeding unit 10 to the posture correction unit 20 one by one.

The paper P supplied to the posture correction unit 20 is conveyed on the feeder board 21 by the paper feed roller 24, the paper feed belt 25, and the paper feed roll 26, and the front edge of the paper P abuts on the front lay 22A at an end point. Thereby, the posture is corrected. That is, the front and rear edges of the paper P are adjusted to a posture orthogonal to the conveying direction (Y direction) by the conveying unit 40, and an inclination (skew) is removed. Further, the paper P is positioned at a fixed position with respect to the conveying direction (Y direction) at the same time as the posture is corrected.

In a case where the paper P abuts on the front lay 22A, the paper P is sent by the side lay roll 23B in the direction (X direction) orthogonal to the conveying direction (Y direction), and one side edge of the paper P abuts on the side lay 23A. Thus, the paper P is positioned at a fixed position with respect to a direction orthogonal to the conveying direction (Y direction).

Through the above processes, the posture of the paper P is corrected, and the paper P is positioned at a fixed position. In a case where the posture of the paper P is corrected by the posture correction unit 20 and the paper P is positioned at a fixed position, the delivery unit 30 delivers the paper P to the conveying unit 40.

First, the paper holding bar 31 moves to the receiving position Y1. Thus, the paper holding bar 31 is positioned directly above the leading end portion of the paper P. In this case, the paper holding bar 31 is disposed such that the attraction surface 31A thereof faces a surface of the paper P with a certain clearance.

In a case where the paper holding bar 31 moves to the receiving position Y1, the suction hole opening/closing valve 33 in an area corresponding to a width of the paper P is opened, and the paper P is sucked through the suction holes 32. Thus, the leading end portion of the paper P is sucked to the attraction surface 31A, and the leading end portion of the paper P is held by the paper holding bar 31. The suction hole opening/closing valve 33 in the area corresponding to the width of the paper P is the suction hole opening/closing valve 33 of the suction hole 32 in an area where the paper P is attracted. By opening only the suction hole opening/closing valve 33 of the suction hole 32 in the area where the paper P is attracted, decrease in the attraction force can be prevented, and the paper P can be stably held.

In a case where the paper P is held by the paper holding bar 31, the feed screw drive motor 37C is driven, and the paper holding bar 31 moves toward the delivery position Y2. In this case, the moving speed of the paper holding bar 31 is controlled such that it becomes the same speed as the conveying belt 41 in a case where the paper holding bar 31 reaches the delivery position Y2. That is, movement of the paper holding bar 31 is controlled such that the paper P is delivered while running at the same speed as the conveying belt 41.

In a case where the paper holding bar 31 reaches the delivery position Y2, holding of the paper P by the paper holding bar 31 is released. That is, all the suction hole opening/closing valves 33 are closed, and the attraction force on the attraction surface 31A is released. Thus, the paper P is released from the paper holding bar 31. In a case where holding of the paper P is released, the paper holding bar 31 stops moving.

On the other hand, the paper P released from the paper holding bar 31 is sucked to the surface of the conveying belt 41 by suction from the suction holes 41A provided in the conveying belt 41. Thus, the paper P is delivered to the conveying belt 41. In this case, the paper P is delivered to the conveying belt 41 while moving at the same speed as the conveying belt 41. Thus, the paper P can be delivered to the conveying belt 41 without causing a shift, an inclination, or the like.

The paper P delivered to the conveying belt 41 is conveyed by the conveying belt 41 at a constant speed along a plane in parallel to the XY plane in the Y direction. Then, in the conveyance process, the paper P passes through the inkjet printing unit 50, and the inkjet heads 51C, 51M, 51Y, and 51Bk drop four colors of ink of cyan, magenta, yellow, and black to print a color image on the surface of the paper P.

The printed paper P is collected by the paper discharging unit 60 at an end point of the conveyance path by the conveying belt 41, and is accumulated on a paper discharge tray.

As described above, according to the inkjet printer 1 of the present embodiment, the paper P is delivered to the conveying belt 41 after the posture is corrected by the posture correction unit 20. In this case, the leading end portion of the paper P is held by the paper holding bar 31 that moves linearly, and is delivered to the conveying belt 41. Thus, the paper P can be delivered to the conveying belt 41 while maintaining a specified posture without changing the posture of the paper P after the correction. Accordingly, printing can be performed without causing a position shift, an inclination, or the like.

### Modification Example

<<Modification Example of Posture Correction Unit>>

The posture correction unit needs only to be able to correct at least the posture of the medium to a specified posture. As the posture correction unit, a known posture correcting mechanism used in an offset printer or the like can be used.

In the above-described embodiment, the paper P is fed using the paper feed roller 24, the paper feed belt 25, and the paper feed roll 26 in a case where the paper P abuts on the front lay 22A. However, the mechanism for feeding the paper P is not limited to this. Other known feed mechanisms can be used.

In the side lay device 23, the paper P is fed using the side lay roll 23B, but the mechanism for feeding the paper P is not limited to this. Other known feed mechanisms can be used.

As described above, the posture correction unit needs only to be able to correct at least the posture of the medium. Therefore, it is not always necessary to perform positioning.

In a case where positioning is performed, positioning may be performed only in one direction. For example, a configuration may be adopted in which positioning is performed only in the conveying direction of the paper. Alternatively, a configuration may be adopted in which positioning is performed only in a direction orthogonal to the conveying direction of the paper. For example, in the posture correction unit 20 of the above-described embodiment, in a case where the side lay device 23 is omitted, positioning can be performed only in the conveying direction of the paper. In a case where the front lay device 22 is omitted, positioning can be performed only in a direction orthogonal to the conveying direction of the paper.

<Example of Positioning in Direction Orthogonal to Conveying Direction of Paper>

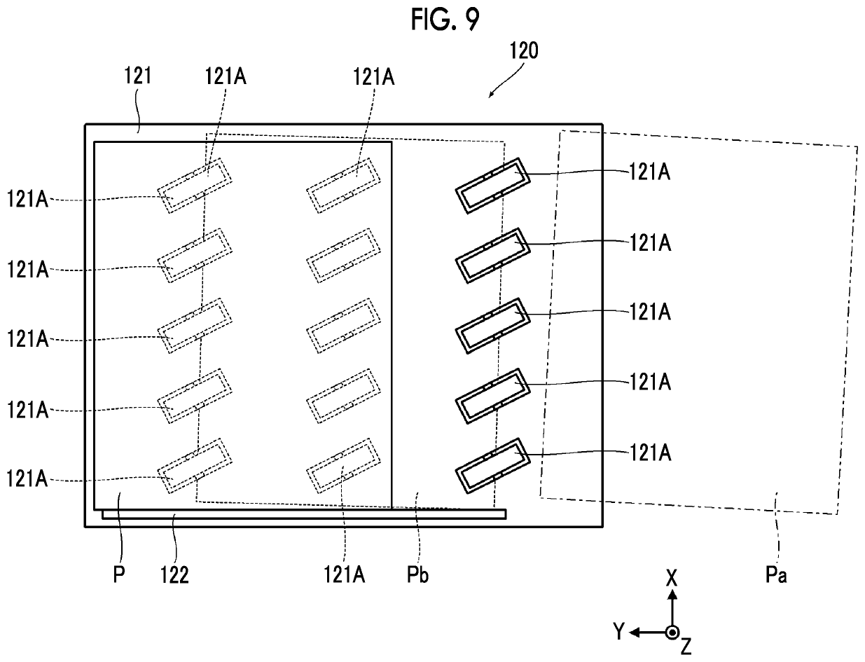

FIG. 9 is a plan view showing an example of a posture correction unit in a case where positioning is performed in a direction orthogonal to a conveying direction of a paper.

A posture correction unit 120 of the present example comprises a feeder board 121 and a side lay 122, and corrects the posture of the paper P by making the side edge of the paper P abut on the side lay 122. At the same time, the paper P is positioned in a direction orthogonal to the conveying direction.

The feeder board 121 comprises a plurality of conveying rollers 121A. Each of the conveying rollers 121A is disposed to be inclined toward the side lay 122. Each of the conveying rollers 121A rotates by being driven by a motor (not shown). The paper P supplied to the feeder board 121 is conveyed obliquely toward the side lay 122 by action of the conveying rollers 121A disposed to be inclined.

The side lay 122 is an example of a regulating member, and is disposed along the delivery direction (Y direction) of the paper P. The side lay 122 is attached so that the position can be adjusted in the X direction.

According to the posture correction unit 120 of the present example, the paper P is conveyed obliquely on the feeder board 121 toward the side lay 122. Then, in the conveyance process, the side edge abuts on the side lay 122, and the posture is corrected. At the same time, positioning is performed in a direction orthogonal to the conveying direction (delivery direction). In FIG. 9, a paper Pa indicated by a dashed line is an initial state paper, a paper Pb indicated by a broken line is an intermediate state paper, and the paper P indicated by a solid line is a final state paper. As shown in the figure, the posture of the paper is corrected in a process of being conveyed on the feeder board 121, and the paper is positioned in a direction orthogonal to the conveying direction.

In the present example, the paper P is fed using the conveying roller 121A in the oblique direction, but the mechanism for feeding the paper P in the oblique direction is not limited to this.

In a case of the posture correction unit 120 of the present example, the position of the paper P in the conveying direction (delivery direction) is uncertain, but a shift of the position of the paper P in the conveying direction can be eliminated by individually adjusting the printing position in the inkjet printing unit 50. That is, by adjusting the printing position to offset a shift, the shift of the position of each paper P in the conveying direction of the paper can be eliminated. The printing position in the conveying direction of the paper can be adjusted by changing a timing at which printing is started. That is, the printing position can be shifted backward by delaying the timing of starting printing. Further, the printing position can be shifted forward by advancing the timing of starting printing.

In a case of adjusting the printing position of the paper P, the position of the paper after the posture correction is detected by a sensor, the detection result is given to the control unit 100, and the printing position in the inkjet printing unit 50 is adjusted.

<Example of Correcting Only Posture of Paper>

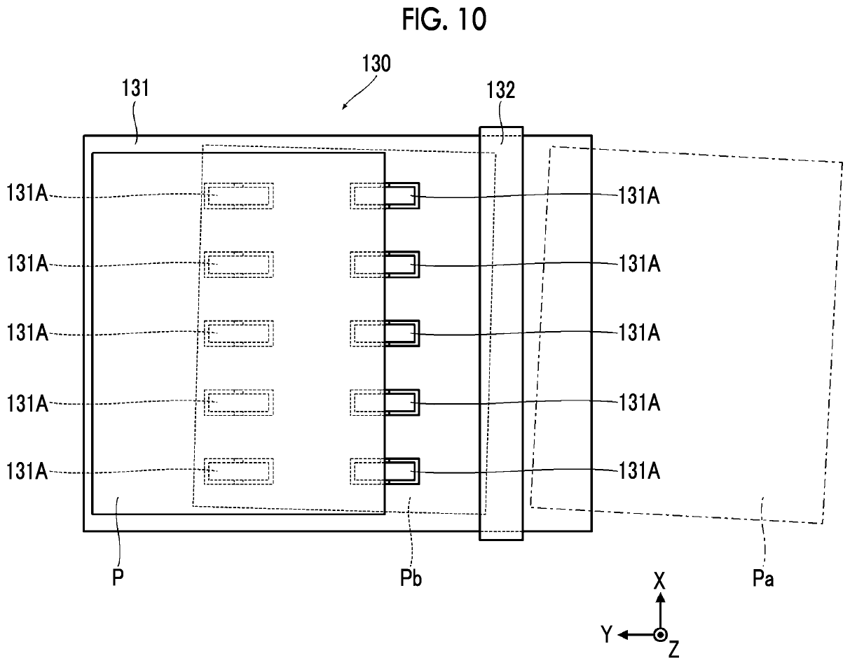

FIG. 10 is a plan view showing an example of a posture correction unit in a case where only a posture of the paper is corrected.

A posture correction unit 130 of the present example comprises a feeder board 131 and a posture detection sensor 132.

The feeder board 131 comprises a plurality of conveying rollers 131A along a direction orthogonal to the conveying direction (delivery direction) of the paper P. In the present example, two rows are provided. Each of the conveying rollers 131A rotates individually by being driven by a motor (not shown). The driving of each motor is individually controlled by the control unit 100 (see FIG. 8).

The posture detection sensor 132 is an example of a posture detecting portion. The posture detection sensor 132 is disposed on an upstream side of the conveying roller 131A. The posture detection sensor 132 is configured by, for example, a line scanner, and reads the front edge (edge on the leading end side) of the paper P to detect the posture of the paper P. The detected information is output to the control unit 100 (see FIG. 8).

The control unit 100 individually drives each conveying roller 131A based on the detection result of the posture of the paper P by the posture detection sensor 132 to correct the posture of the paper P. That is, by providing a difference in the rotation speed of each conveying roller 131A, the paper P rotates around the Z axis while being conveyed, and the posture is corrected.

In FIG. 10, the paper Pa indicated by a dashed line is an initial state paper, the paper Pb indicated by a broken line is an intermediate state paper, and the paper P indicated by a solid line is a final state paper. The front edge of the paper supplied from the paper feeding unit 10 is read in a process of passing through the posture detection sensor 132, and the posture is detected. Then, the rotation speed of each conveying roller 131A is individually determined based on the detection result of the posture. That is, the rotation speed of each conveying roller 131A is individually determined so that the inclination generated on the paper is removed. Then, each conveying roller 131A is driven at the determined rotation speed, and the paper is conveyed. Thus, the posture of the paper can be corrected.

In a case of the posture correction unit 120 of the present example, the position of the paper P is uncertain, but a shift of the position of each paper P can be eliminated by individually adjusting the printing position in the inkjet printing unit 50. That is, by adjusting the printing position to offset a shift, the shift of the position occurring on each paper can be eliminated. As described above, the printing position in the conveying direction of the paper can be adjusted by changing a timing at which printing is started. On the other hand, the printing position in a direction orthogonal to the conveying direction of the paper can be adjusted by switching an area of a nozzle used for printing in a width direction (X direction). This adjustment is possible in a case where the printing width of an inkjet head (a length of a nozzle row in the X direction) is wider than the width of the paper.

In a case of adjusting the printing position of the paper P, the position of the paper after the posture correction is detected by a sensor, the detection result is given to the control unit 100, and the printing position in the inkjet printing unit 50 is adjusted.

<<Modification Example of Delivery Unit>>

The delivery unit needs only to be able to hold a part of the medium and convey it linearly. It is preferable that the part to be held is appropriately set according to the medium. For example, in a case of a medium that is hardly deformed, the delivery unit may convey the medium while holding a central portion thereof.

In a case where a medium for printing that is thin and easily deformed is delivered, it is preferable to hold the leading end portion as in the above-described embodiment. In this case, it is more preferable to hold a non-printing area. The non-printing area is a so-called margin area, and is an area where printing is not performed. The non-printing area is generally set in a frame shape at a peripheral portion of the paper, and is set as an area that is cut and removed after printing.

Further, in the above-described embodiment, the paper as the medium is attracted and held, but a form of holding the paper is not limited to this. For example, a configuration may be adopted in which the leading end portion of the paper is gripped by a gripper. In a case where the paper is attracted and held, the paper may be attracted onto the holding portion using static electricity. In a case where the paper is delivered to the conveyance mechanism for conveying the paper along the plane, such as a conveying belt, the delivery position of the paper can be set randomly by attracting and holding the paper. Thereby, a degree of freedom in design can be improved.

In the above-described embodiment, the paper P is delivered to the conveying belt 41 at a time when the suction hole 32 of the paper holding bar 31 passes the start point Y4 of the suction action. However, the delivery position Y2 of the paper P is not limited to this. It is preferable the position is appropriately set according to a type of the paper or the like.

In the above-described embodiment, each suction hole 32 can be opened and closed individually, but may be opened and closed collectively. For example, in an apparatus that handles a single size paper, a configuration may be adopted in which all suction holes are opened and closed collectively using a common valve.

In the above-described embodiment, the paper holding bar is moved using the feed screw mechanism, but the mechanism for moving the paper holding bar is not limited to this. For example, a linear motor may be used as driving means. In addition, it is preferable to use, as a guide mechanism, a mechanism having high reproducibility of the conveying operation position, such as a linear motion guide (also referred to as a linear slider). Thus, position reproducibility for each paper can be secured.

As necessary, the holding portion may comprise an up-and-down mechanism. For example, in the delivery unit 30 of the above-described embodiment, a mechanism for moving the paper holding bar 31 up and down (Z direction) may be provided. Thus, in a case of receiving the paper P, the attraction surface 31A of the paper holding bar 31 can be brought into close contact with the paper P to receive the paper P.

<<Speed of Paper in Case of being Delivered to Conveying Unit>>

It is preferable that the speed of the paper in a case where the paper is delivered from the delivery unit to the conveying unit is made to match the conveying speed of the paper by the conveying unit. However, in a case where it is within a range of a certain speed difference, the same effect as a case where the speeds are made to match with each other can be expected. Therefore, an experiment was performed in which the papers were delivered at different speeds, and changes in the postures of the delivered papers were confirmed.

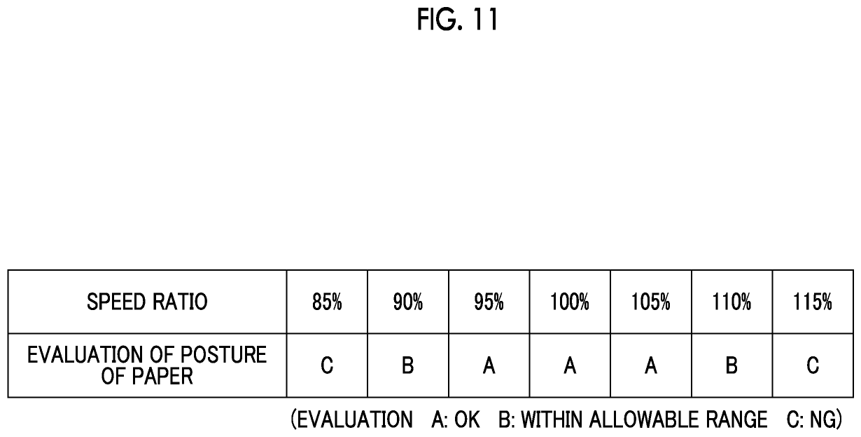

FIG. 11 is a table showing results of the experiment.

In the table shown in the figure, an item of a speed ratio is a speed ratio with respect to the conveying speed of the paper by the conveying unit (the running speed of the conveying belt). A speed ratio of 85% means that the paper was delivered at a speed of 85% with respect to the conveying speed of the paper by the conveying unit. A speed ratio of 100% is a case where the paper was delivered at the same speed.

In addition, evaluation was made in three stages of A, B, and C. A means that there was no change in posture. That is, it means that the paper was delivered while maintaining the posture at the time of correction. B means that a change in posture (inclination (skew) or the like) was recognized, but within an allowable range. C is a case where an unacceptable change in posture occurred.

As shown in the table of FIG. 11, in a case where the paper is delivered at a speed within a range of ±10% of the conveying speed of the paper by the conveying unit, the paper can be delivered to the conveying unit without changing the posture.

<<Modification Example of Conveying Unit>>

The conveying unit needs only to have a configuration that can convey the medium along the plane.

In the above-described embodiment, the paper as the medium is conveyed along the plane by the so-called belt conveyance mechanism, but the mechanism for conveying the medium along the plane is not limited to this. For example, a conveyance mechanism using a table may be used. The conveyance mechanism using the table places the medium on the table, slides the table along the plane, and conveys the medium along the plane. In this case, the delivery of the medium may be performed with the table stopped, or may be delivered while moving the table. In a case where the medium is delivered to the moving table, it is preferable to accelerate and deliver the paper to the same speed as the table.

Further, in the above-described embodiment, the paper as the medium is attracted onto the conveying belt using air pressure, but the mechanism for attracting the medium to the conveying belt is not limited to this. The medium may be attracted onto the conveying belt by using static electricity. In this case, the conveying belt is charged to a high voltage.

Further, the medium may be conveyed by being held by holding means other than attraction. For example, the medium may be conveyed by gripping the leading end with a gripper.

A mechanism for holding the medium, such as attraction, is not necessarily required in the conveying unit. For example, in the case of a heavy medium, the medium can be stably conveyed without attraction. Therefore, in a case of the medium that can be stably conveyed without attraction or the like, a holding mechanism such as attraction is unnecessary. In this case, the medium is simply placed and conveyed without attraction or the like.

In a case where the paper is conveyed by the conveying belt without being attracted, it is preferable to deliver the paper from the delivery unit to the conveying unit at a stage where the entire or almost the entire paper is located on the conveyance path by the conveying belt.

### Other Modification Examples

In the above-described embodiment, the case where the medium conveying device according to the embodiment of the present invention is applied to the conveying device of the inkjet printer has been described as an example, but the application of the medium conveying device according to the embodiment of the present invention is not limited to this. The present invention can be applied to a conveying device of a printer other than the inkjet method.

Further, the present invention can be applied to a conveying device that conveys a medium other than the medium for printing. For example, the present invention can be applied to a conveying device that conveys a substrate or the like.

In the above-described embodiment, the paper is discharged as it is after printing, but a post-processing process such as drying may be added as necessary.

### EXPLANATION OF REFERENCES

1: inkjet printer
10: paper feeding unit
20: posture correction unit
21: feeder board
22: front lay device
22A: front lay
22B: front lay shaft
23: side lay device
23A: side lay
23B: side lay roll
24: paper feed roller
25: paper feed belt
26: paper feed roll
30: delivery unit
31: paper holding bar
31A attraction surface
31B: common space
32: suction hole
32A: pad
33: suction hole opening/closing valve
34: paper holding bar suction pump
35: paper holding bar moving mechanism
36: linear motion guide
36A: base
36B: guide rail
36C: slider
36D: slide table
37: paper holding bar driving mechanism
37A: feed screw
37B: nut
37C: feed screw drive motor
40: conveying unit
41: conveying belt
41A: suction hole
42: driving roller
43: driven roller
44: conveying belt drive motor
45: rotary encoder
46: suction chamber
47: conveying belt suction pump
50: inkjet printing unit
51C: inkjet head
51M: inkjet head
51Y: inkjet head
51Bk: inkjet head
60: paper discharging unit
100: control unit
101: operation unit
102: display unit
103: communication unit
104: storage unit
120: posture correction unit
121: feeder board
121A: conveying roller
122: side lay
130: posture correction unit
131: feeder board
131A: conveying roller
132: posture detection sensor
P: paper
Pa: paper
Pb: paper
Y1: receiving position
Y2: delivery position
Y3: start point of conveyance path
Y4: start point of suction action

What is claimed is:

1. A medium conveying device comprising:
a posture correction unit that corrects a posture of a medium;
a conveying unit that conveys the medium along a plane; and
a delivery unit that delivers the medium of which the posture is corrected by the posture correction unit to the conveying unit,
wherein the delivery unit includes a holding portion that holds a part of the medium of which the posture is corrected by the posture correction unit, and delivers the medium to the conveying unit by moving the holding portion linearly along a conveying direction of the medium by the conveying unit.

2. The medium conveying device according to claim 1,
wherein the delivery unit accelerates the holding portion to the same speed as a conveying speed of the medium by the conveying unit, and delivers the medium held by the holding portion to the conveying unit.

3. The medium conveying device according to claim 1,
wherein the delivery unit accelerates the holding portion to a speed within a range of ±10% of a conveying speed of the medium by the conveying unit, and delivers the medium held by the holding portion to the conveying unit.

4. The medium conveying device according to claim 1,
wherein the conveying unit conveys the medium by a belt.

5. The medium conveying device according to claim 4,
wherein the conveying unit conveys the medium by attracting the medium onto the belt.

6. The medium conveying device according to claim 5,
wherein the holding portion attracts and holds a leading end portion of the medium, and
the delivery unit delivers the medium to the conveying unit by moving the holding portion to a position where an attraction force by the belt acts.

7. The medium conveying device according to claim 6,
wherein the holding portion attracts and holds the leading end portion of the medium with a plurality of suction holes which can be individually opened and closed, and
the suction holes are individually opened and closed according to a size of the medium.

8. The medium conveying device according to claim 1,
wherein the posture correction unit corrects the posture of the medium and positions the medium at a fixed position.

9. The medium conveying device according to claim 4,
wherein the posture correction unit corrects the posture of the medium and positions the medium at a fixed position.

10. The medium conveying device according to claim 5,
wherein the posture correction unit corrects the posture of the medium and positions the medium at a fixed position.

11. The medium conveying device according to claim 6,
wherein the posture correction unit corrects the posture of the medium and positions the medium at a fixed position.

12. The medium conveying device according to claim 8,
wherein the posture correction unit corrects the posture of the medium and positions the medium at the fixed position by making the medium abut on a first regulating member disposed along a direction orthogonal to a delivery direction of the medium and a second regulating member disposed along the delivery direction of the medium.

13. The medium conveying device according to claim 1,
wherein the posture correction unit corrects the posture of the medium and positions the medium at a fixed position with respect to a delivery direction of the medium.

14. The medium conveying device according to claim 13,
wherein the posture correction unit corrects the posture of the medium and positions the medium at the fixed position with respect to the delivery direction of the medium by making the medium abut on a regulating member disposed along a direction orthogonal to the delivery direction of the medium.

15. The medium conveying device according to claim 1,
wherein the posture correction unit corrects the posture of the medium and positions the medium at a fixed position with respect to a direction orthogonal to a delivery direction of the medium.

16. The medium conveying device according to claim 15,
wherein the posture correction unit corrects the posture of the medium and positions the medium at the fixed position in the direction orthogonal to the delivery direction of the medium by making the medium abut on a regulating member disposed along the delivery direction of the medium.

17. The medium conveying device according to claim 1,
wherein the posture correction unit includes
a posture detecting portion that detects the posture of the medium,
a plurality of conveying rollers disposed along a direction orthogonal to a delivery direction of the medium, and
a control unit that individually controls rotation speeds of the conveying rollers based on a detection result of the posture detecting portion and corrects the posture of the medium.

18. An inkjet printer comprising:
the medium conveying device according to claim 1; and
an inkjet printing unit that performs printing on the medium conveyed by the conveying unit of the medium conveying device by an inkjet method.
